(19) United States
(12) Patent Application Publication
(10) Pub. No.: US 2024/0399607 A1
(43) Pub. Date: Dec. 5, 2024

(54) PUNCHING CYLINDER FOR THE ROTARY CUTTING OF A MATERIAL WEB, AND PUNCHING SHEET

(71) Applicant: OPTIMA life science GmbH, Schwäbisch Hall (DE)

(72) Inventors: Rolf Grotehusmann, Mainhardt (DE); Johannes Jansen, Michelfeld (DE)

(73) Assignee: OPTIMA life science GmbH, Schwäbisch Hall (DE)

(21) Appl. No.: 18/690,188

(22) PCT Filed: Aug. 17, 2022
(86) PCT No.: PCT/EP2022/072935

§ 371 Date: Mar. 7, 2024

(30) Foreign Application Priority Data
Sep. 9, 2021 (DE) 20 2021 104 878.6

(51) Int. Cl. B26F 1/44; B26F 1/38

(52) U.S. Cl. CPC B26F 1/44; B26F 1/384

(57) ABSTRACT

The invention relates to a punching apparatus in the form of a punching cylinder (1) for the rotary cutting of a material web (4), or in the form of a punching sheet (10) for mounting on a cylinder (1) for the rotary cutting of a material web (4), wherein a cutting contour (12) is provided on a circumference of the punching cylinder (1), or on a surface of the punching sheet (10), and a track (3) with a multiplicity of circumferentially spaced-apart cutting teeth (30) is provided at least in the circumferential portion of the cutting contour (12) on the circumference of the punching cylinder (1), or a track (3) which runs in the longitudinal direction (II) and has a multiplicity of longitudinally spaced-apart cutting teeth (30) is provided at least in the portion of the cutting contour (12) on the surface of the punching sheet (10).

### TECHNICAL FIELD AND PRIOR ART

The invention relates to a punching device in the form of a punching cylinder for the rotary cutting of a material web, or in the form of a punching sheet for mounting on a cylinder for the rotary cutting of a material web, wherein a cutting contour is provided on a rolling circumference of the punching cylinder or on a surface of the punching sheet.

For cutting thin materials, e.g. papers, plastic films, adhesive label materials, metal foils, textiles, fleece, materials for flexible circuit boards, and material layers of a fuel cell or similar, it is known to use punching devices which have cutting contours with sharp cutting edges. For rotary cutting of a material web, as well as the use of a cylinder with cutting contours on its surface, so-called punching sheets are known which are mounted on a cylinder.

The punching sheets are applied to a cylinder by means of a clamping strip, by vacuum and/or by magnetic force. For precise positioning of the punching or embossing sheet on the cylinder, it is known to provide a stop edge or openings or a fold at a front end of the punching sheet. For mounting the punching sheet, the fold is laid on a corresponding recess of the cylinder. Openings or stop edges are oriented on register pins on the cylinder.

In the text below, the term “punching cylinder” is used both for cylinders with a cutting contour provided on the surface of the cylinder and also for cylinders with punching sheets arranged thereon.

For rotary cutting, the material web is guided through a gap between the punching cylinder and a counter-cylinder during use.

### Object and Solution

It is an object of the invention to provide a punching cylinder which allows slip-free movement of the punching cylinder and a material web to be processed during the cutting process.

This object is achieved by the punching cylinder and the punching sheet with the features of claims 1 and 9. Further advantageous embodiments arise from the dependent claims.

According to a first aspect, a punching cylinder is provided for the rotary cutting of a material web with a cutting contour, wherein at least in the circumferential portion of the cutting contour, a track is provided on a rolling circumference, the track comprising a plurality of cutting teeth spaced apart in the circumferential direction.

According to a second aspect, a punching sheet is provided for mounting on a cylinder for the rotary cutting of a material web, wherein a cutting contour is provided on a surface of the punching sheet, and wherein at least in the portion of the cutting contour, a track running in the longitudinal direction is provided on the surface of the punching sheet, the track comprising a plurality of cutting teeth spaced apart in the longitudinal direction.

The longitudinal direction of the punching sheet is an extent of the punching sheet which corresponds to the circumferential direction after the punching sheet has been mounted on the cylinder.

The terms “a”, “an” etc. are used in connection with the application as indefinite articles and not as numbers. In particular, in some embodiments of the punching cylinder, more than one track and/or more than one cutting contour may be provided.

The track with the cutting teeth is also referred to in connection with the application as a tractor track. During processing of the material web, the cutting teeth of the track cut into the latter and thus establish a slip-free movement of the punching cylinder and the material web during the cutting process. Preferably, the track extends over the entire circumference of the punching cylinder so as to ensure a continuous, slip-free movement of the material web. However, embodiments are also conceivable in which a length of the track is restricted to a circumferential portion of the punching cylinder with a cutting contour.

Due to the track, in particular due to multiple tracks, it is possible to prevent a lateral twist of the material web so as to keep the cutting contour on the material web within a close line tolerance.

In one embodiment, the punching cylinder comprises a cylinder and a punching mounted thereon, wherein the cutting teeth are arranged on the punching sheet or on a shell surface of the cylinder.

In advantageous embodiments, the track is arranged such that the material web is cut by the cutting teeth only in a residual material resulting from the cutting process, in particular a residual grid.

The cutting teeth are preferably identical and evenly distributed along the track so as to allow an even force action with simple geometry.

In one embodiment, in an application, punching cylinders with tractor tracks are used to achieve a complete cut through a material web which is transported without cutting underlay. Punching cylinders with tractor tracks may also be used in an embodiment in order to make a cut in a material web arranged on a carrier web, wherein by means of the cutting contour, only the material web and not the carrier web is cut. Such a cut in the context of the applications is referred to a kiss cut. In one embodiment, the cutting teeth are suitably designed for latching the material web with the carrier web arranged underneath.

In one embodiment, the cutting teeth are higher than the cutting contour. In other words, the cutting teeth protrude beyond the cutting contour in the radial direction during use. In other embodiments, the cutting teeth and the cutting contour have at least substantially the same height.

In one embodiment, the cutting teeth are suitably arranged so as to apply a transverse force relative to a circumferential direction of the punching cylinder during cutting and/or because of the latch generated by the cut.

In one embodiment, the cutting teeth run obliquely and/or in a curve relative to the circumferential direction. The term “obliquely” here means an arrangement of the cutting teeth with an acute or obtuse angle relative to the circumferential direction. If the track is arranged eccentrically, preferably an even number of tracks is provided which are arranged mirror-symmetrically to a center line of the punching sheet, wherein the cutting teeth are preferably arranged such that a front end of each cutting tooth in the circumferential direction points in the direction of the center line. Thus a transverse force is applied relative to a circumferential direction of the punching cylinder, which stretches the material web in the direction of its lateral edges.

Alternatively, in one embodiment the cutting teeth are hook-shaped or sickle-shaped. In this case, the cutting teeth are preferably arranged such that an apex of each cutting tooth points in the transport direction of the material web, i.e. an apex of each cutting tooth on a punching sheet points in the direction of a front end of the punching sheet. The arrangement is particularly advantageous for a centrally arranged track, wherein by means of the cutting teeth, a transverse force is applied relative to a circumferential direction of the punching cylinder, which stretches the material web in the direction of its lateral edges.

In one embodiment, it is provided that ends of the cutting teeth of the track are arranged directly adjacent to one another or overlapping in the circumferential direction. The overlapping or adjacent arrangement achieves that, throughout the cutting process, at all times at least one cutting tooth is in engagement with the material web and fixes this for slip-free movement.

In one embodiment, precisely one track is provided, wherein the track is arranged in particular centrally on the punching cylinder.

In another embodiment, two tracks are provided, wherein the tracks are arranged in particular at opposite ends of the punching cylinder and/or edges of the punching sheet. In one embodiment, a further track is provided centrally on the punching cylinder or punching sheet.

In advantageous embodiments, the cutting teeth of the two tracks are arranged mirror-symmetrically in order each to apply an outwardly directed transverse force. In particular, in an embodiment, two tracks with obliquely and/or curvingly arranged cutting teeth are provided at the opposite ends of the punching cylinder or punching sheet, wherein front ends of the cutting teeth in the circumferential direction each point in the direction of the center line. In one embodiment, in addition to the two tracks provided at the edges, a central track is provided.

The tracks may be designed suitably for each application by the person skilled in the art in order to achieve a slip-free movement, with or without latching of the material web with a carrier web.

### BRIEF DESCRIPTION OF THE DRAWINGS

Further advantages and aspects of the invention arise from the claims and also from the following description of exemplary embodiments of the invention which are explained with reference to the drawings. In the drawings:

FIG. 1 shows a side view of a punching cylinder with an applied punching sheet;

FIG. 2 shows a top view of an exemplary embodiment of a punching sheet with two tracks before mounting on a punching cylinder;

FIG. 3 shows a top view of a further exemplary embodiment of a punching sheet with a track before mounting on a punching cylinder;

FIG. 4 shows schematically an alternative track for a punching sheet or a punching cylinder.

### DETAILED DESCRIPTION OF THE EXEMPLARY EMBODIMENTS

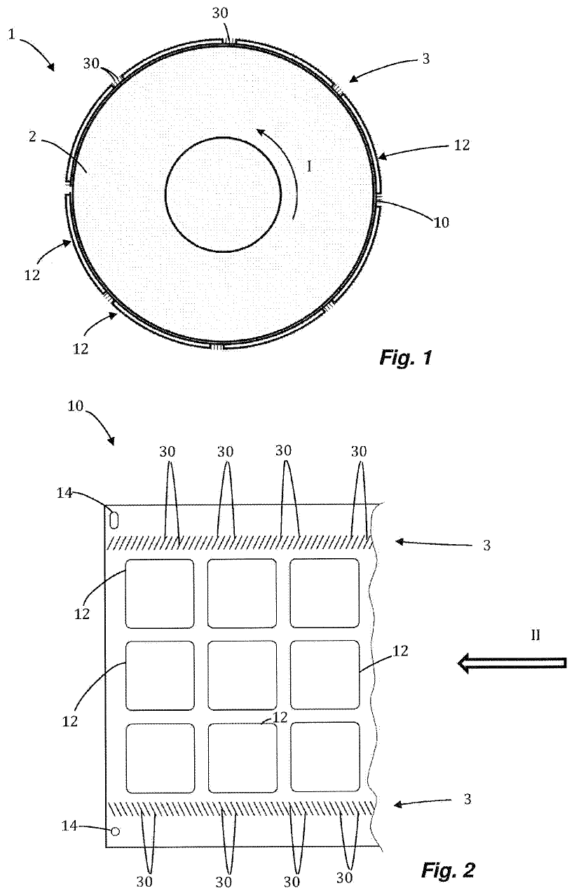

FIG. 1 shows schematically a side view of a punching cylinder 1 with multiple punching or cutting contours 12. In the exemplary embodiment illustrated, the cutting contours 12 are formed on a punching sheet 10 which is mounted on a cylinder 2, in particular a magnetic cylinder. The illustration is purely schematic and the arrangement and/or size of the punching sheet 10, the cutting contour 12 and/or the cylinder 2, are not to scale. The person skilled in the art will in particular arrange the cutting contours 12 for creating a punching cylinder 1 so that the cutting contours 12 allow an even processing of a material web 4 without offset.

During use, the punching cylinder 1 illustrated rotates in a rotational direction I illustrated by an arrow. The punching cylinder 1 cooperates with a counter-element (not shown), in particular a counter-cylinder, in order to cut the material web (not shown) which is guided through a gap between the punching cylinder and the counter-element. In one application, the material web is arranged on a carrier web, wherein the cutting contour 12 cuts the material web but not the carrier web.

To mount the punching sheet 10 on the shell surface of the cylinder 2, permanent magnets (not shown in the figure) for example are provided on the cylinder 2 and exert an attraction force on a punching sheet 10 made of a ferromagnetic material, in particular a ferromagnetic steel. Alternatively, it is conceivable to mount the punching sheet 10 on the shell surface of the cylinder 2 by means of an applied vacuum.

The punching cylinder 1 has a track 3 with a plurality of cutting teeth 30. In the exemplary embodiment shown, the cutting teeth 30 and the cutting contour 12 have at least substantially the same height. The height of the cutting teeth 30 and the cutting contour 12 is shown purely schematically and not to scale.

For a kiss cut, the cutting contour 12 does not penetrate the cutting web, or only penetrates this deeply enough for it not to be cut through. In one embodiment, the cutting teeth 30 are configured such that during use, the cutting teeth 30 make a cut in the material web through which the material web latches the underlying carrier web.

FIG. 2 shows schematically a top view of an exemplary embodiment of a punching sheet 10 with multiple cutting contours 12, which in the exemplary embodiment shown are arranged in three rows. Openings 14 for positioning on register pins (not shown) of the cylinder 2 are provided at a front end of the illustrated punching sheet 10 (see FIG. 1). In an alternative embodiment, the punching sheet 10 has a fold at a front end, via which the punching sheet 10 lies on a recess provided on the shell surface of the cylinder 2 and is thus positioned.

The punching sheet 10 shown in FIG. 2 has two tracks 3 which each extend in a longitudinal direction II illustrated by an arrow. Each track 3 comprises a plurality of cutting teeth 30. In the exemplary embodiment shown in FIG. 2, the tracks 3 are arranged at the mutually opposite edges of the punching sheet 10. In the exemplary embodiment illustrated in FIG. 2, the cutting teeth 30 of the two tracks 3 are each arranged obliquely relative to the longitudinal direction II, i.e. they form an angle with the longitudinal direction II. The angle may be selected suitably by the person skilled in the art depending on application.

In the exemplary embodiment illustrated, the tracks 3 are arranged mirror-symmetrically relative to a center line of the punching sheet 10. A front end of the cutting teeth 30 points in the direction of the center line, and a rear end points in the direction of an outer edge of the punching sheet 10.

The obliquely arranged cutting teeth 30 penetrate into the material web (not shown) during a cutting process and ensure a slip-free movement of the punching cylinder 1 (see FIG. 1) and the material web.

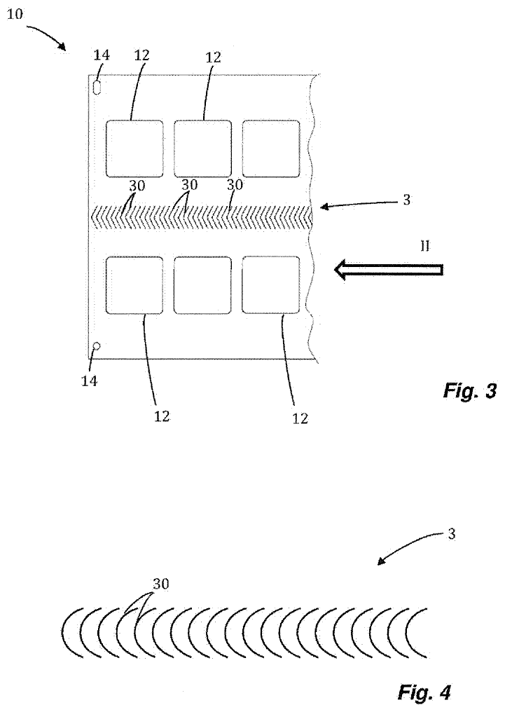

FIG. 3 shows schematically a top view of a second exemplary embodiment of a punching sheet 10 with multiple cutting contours 12, which in the exemplary embodiment shown are arranged in two rows. Openings 14 for positioning on register pins (not shown) of a cylinder 2 are provided at a front end of the illustrated punching sheet 10 (see FIG. 1).

The punching sheet 10 shown in FIG. 3 has a track 3 extending in a longitudinal direction II, illustrated schematically by an arrow and arranged centrally on the punching sheet 10. The track 3 comprises a plurality of hook-shaped cutting teeth 30. In the exemplary embodiment illustrated, the apex of the hook-shaped cutting teeth 30 lies on a center line of the punching sheet 10 and points forward in the longitudinal direction II in the direction of the fold 14.

The hook-shaped cutting teeth 30 engage in a material web (not shown) during a cutting process and ensure a slip-free movement of the punching cylinder 1 and material web.

FIG. 4 shows schematically an alternative track 3 for a punching sheet 10 (not shown in FIG. 4). The track 3 shown in FIG. 4 has a plurality of sickle-shaped cutting teeth 30. Depending on application, the track 3 may be arranged at one edge of a punching sheet 10 or centrally on a punching sheet 10.

As evident to the person skilled in the art, numerous derivatives are conceivable. In an exemplary embodiment (not shown), three tracks are provided on the punching sheet, namely a center track with hook-shaped cutting teeth 30 according to FIG. 3 or with sickle-shaped cutting teeth 30 according to FIG. 4, and two tracks provided at the edges of the punching sheet with oblique cutting teeth according to FIG. 2. In yet further embodiments, a punching sheet is provided which has a central track with oblique cutting teeth according to FIG. 2, or a punching sheet with two tracks arranged at the edges with hook-shaped cutting teeth 30 according to FIG. 3, or sickle-shaped cutting teeth according to FIG. 4. In yet a further embodiment, two tracks running centrally between the cutting contours are provided with oblique cutting teeth according to FIG. 2. It is furthermore conceivable, alternatively or additionally, to provide tracks between the rows of cutting contours 12 according to FIG. 2.

In the embodiments illustrated, the cutting teeth 30 and the cutting contours have at least approximately the same height. In other embodiments, the cutting teeth 30 protrude beyond the cutting contour 12 in the radial direction.

1. A punching cylinder for the rotary cutting of a material web, wherein a cutting contour is provided on the rolling circumference of the punching cylinder, wherein at least in the circumferential portion of the cutting contour, a track is provided on the rolling circumference, the track comprising a plurality of cutting teeth spaced apart in the circumferential direction.

2. The punching cylinder as claimed in claim 1, wherein the cutting teeth run obliquely and/or in a curve relative to a circumferential direction of the punching cylinder.

3. The punching cylinder as claimed in claim 1, wherein the cutting teeth are hook-shaped or sickle-shaped, wherein in particular an apex of each cutting tooth points in the transport direction of the material web.

4. The punching cylinder as claimed in claim 1, wherein ends of the cutting teeth are arranged directly adjacent to one another or overlapping in the circumferential direction.

5. The punching cylinder as claimed in claim 1, wherein precisely one track is provided, wherein the track is arranged in particular centrally on the punching cylinder.

6. The punching cylinder as claimed in claim 1, wherein two tracks are provided, wherein the tracks are arranged in particular at opposite ends of the punching cylinder.

7. The punching cylinder as claimed in claim 6, wherein the cutting teeth of the two tracks are arranged mirror-symmetrically in order each to apply an outwardly directed transverse force.

8. The punching cylinder as claimed in claim 1, wherein the punching cylinder comprises a cylinder with a punching sheet applied thereto.

9. A punching sheet for mounting on a cylinder for the rotary cutting of a material web, wherein a cutting contour is provided on a surface of the punching sheet, wherein at least in the portion of the cutting contour, a track running in the longitudinal direction is provided on the surface of the punching sheet, the track comprising a plurality of cutting teeth spaced apart in the longitudinal direction.

10. The punching sheet as claimed in claim 9, wherein the cutting teeth run obliquely and/or in a curve relative to the longitudinal direction.

11. The punching sheet as claimed in claim 9, wherein the cutting teeth are hook-shaped or sickle-shaped, wherein in particular an apex of each cutting tooth points in the direction of a front end of the punching sheet.

12. The punching sheet as claimed in claim 9, wherein ends of the cutting teeth are arranged directly adjacent to one another or overlapping in the longitudinal direction.

13. The punching sheet as claimed in claim 9, wherein precisely one track is provided, wherein the track is arranged in particular centrally on the punching sheet.

14. The punching sheet as claimed in claim 9, wherein two tracks are provided, wherein the tracks are arranged in particular at opposite edges of the punching sheet.

15. The punching sheet as claimed in claim 14, wherein the cutting teeth of the two tracks are arranged mirror-symmetrically in order each to apply an outwardly directed transverse force.
